(19) United States
(12) Patent Application Publication
(10) Pub. No.: US 2018/0237130 A1
(43) Pub. Date: Aug. 23, 2018

(54) AIRCRAFT USING ENERGY RECOVERY SYSTEMS

(71) Applicant: MRA SYSTEMS, INC., Baltimore, MD (US)

(72) Inventors: David Patrick CALDER, Baltimore, MD (US); Graham Patrick HOWARTH, Middletown, DE (US)

(21) Appl. No.: 15/550,080

(22) PCT Filed: Dec. 31, 2014
(86) PCT No.: PCT/US2014/072967

§ 371 Date: Aug. 10, 2017

(51) Int. Cl. B64C 25/40; B64C 25/42; B64C 25/36; B64D 13/06

(52) U.S. Cl. CPC B64C 25/405; B64D 2013/0648; B64C 25/36; B64C 25/42

(57) ABSTRACT

An aircraft comprises an energy output component (EOC) outputting waste energy. An energy recovery unit (ERU) is operably coupled to the EOC to convert the waste energy into one of electrical energy or mechanical energy. An energy storage unit (ESU) is operably coupled to the ERU to store the one of electrical energy or mechanical energy recovered from the waste energy.

### BACKGROUND OF THE INVENTION

In addition to powering the aircraft for flight, modern aircraft engines also provide power for the aircraft auxiliary systems which may be electrical, hydraulic or pneumatic and include environmental systems, flight control systems and passenger entertainment systems among many applications. The need to provide additional power for these systems may lead to additional capacity/size for auxiliary gearboxes, pumps, generators and their associated supply systems including the tubes, hoses, valves and wiring harnesses. Traditionally, aircraft thrust reversers, which provide increased safety through shorter stopping distances, particularly in emergency situations and bad weather conditions are one of the auxiliary systems with a short term, high power demand. This requirement has resulted in the need for increased hydraulic pump sizing to provide the necessary hydraulic flow or increased generator sizing to provide electrical power and in other cases the careful design consideration and scheduling of engine bleed power available during thrust reverser and other auxiliary system operation.

### BRIEF DESCRIPTION OF THE INVENTION

In one aspect, an embodiment of the invention relates to an aircraft comprising an energy output component (EOC) outputting waste energy. An energy recovery unit (ERU) is operably coupled to the EOC to convert the waste energy into one of electrical energy or mechanical energy. An energy storage unit (ESU) is operably coupled to the ERU to store the one of electrical energy or mechanical energy recovered from the waste energy. A transient, energy consuming component (TECC) is operably coupled to the ESU for receiving one of electrical energy or mechanical energy from the ESU during the operation of the TECC.

### BRIEF DESCRIPTION OF THE DRAWINGS

In the drawings:

FIG. 1 is a block diagram depicting an aircraft according to an embodiment of the invention.

FIG. 2 is a side view of the aircraft of FIG. 1 with multiple, energy output components and multiple energy consuming components according to an embodiment of the invention.

FIG. 3 is a flow chart depicting the aircraft of FIG. 2 using energy recovery systems according to one embodiment of the invention.

FIG. 4 is a flow chart depicting the aircraft of FIG. 2 using energy recovery systems according to another embodiment of the invention.

### DESCRIPTION OF EMBODIMENTS OF THE INVENTION

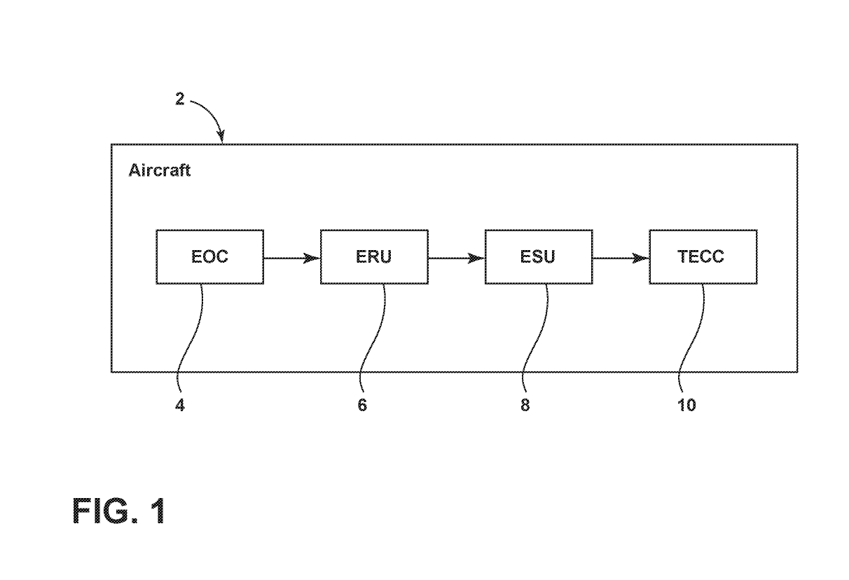

FIG. 1 illustrates an aircraft 2 according to an embodiment of the invention. The aircraft 2 includes at least one energy output component (EOC) 4 which outputs waste energy. An energy recovery unit (ERU) 6 is operably coupled to the EOC 4 to convert the waste energy into one of electrical energy or a mechanical energy. An energy storage unit (ESU) 8 is operably coupled to the ERU 6 to store the one of electrical energy or mechanical energy recovered from the waste energy. A transient, energy consuming component (TECC) 10 is operably coupled to the ESU 8 for receiving one of electrical energy or mechanical energy from the ESU 8 during the operation of the TECC 10.

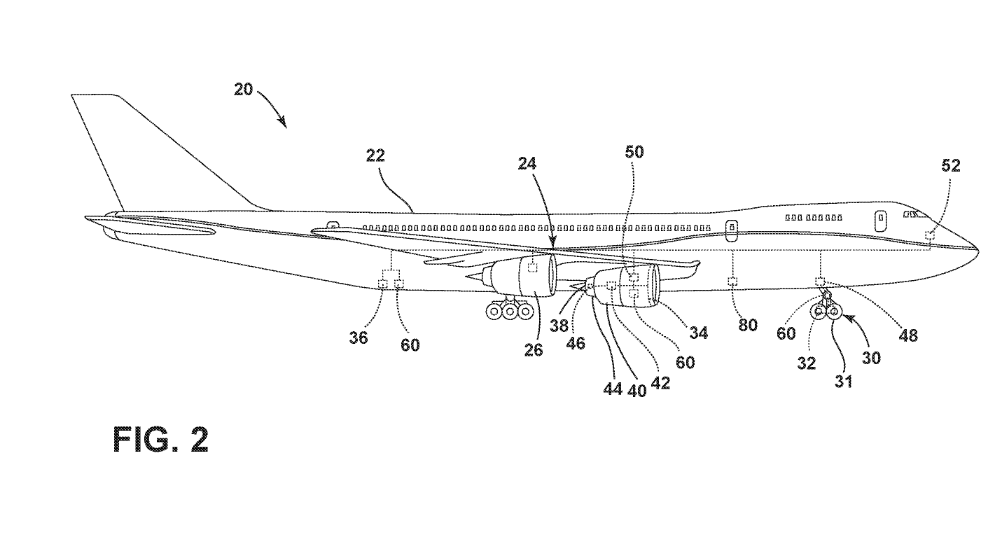

The aircraft 2 may have multiple components or systems that serve as the EOC 4 and TECC 10. As seen in FIG. 2, an aircraft 20 includes a fuselage 22 with wing assemblies 24 extending outward from the fuselage 22. One or more turbofan jet engine assemblies 26 may be coupled to the aircraft 20 to provide propulsion. While a commercial aircraft 20 having turbofan jet engine assemblies 26 has been illustrated, it is contemplated that embodiments of the invention may be used in any type of aircraft, for example, without limitation, fixed-wing, rotating-wing, and military aircraft, and may be used for any type of engine, for example, without limitation, turboshaft, turbojet, turboprop and reciprocating engines.

The energy output components may include aircraft landing gear 30 comprising a wheel 31 having aircraft brakes 32, an engine exhaust system output 38 and an anti-ice system bleed 34 operably coupled to the engine assemblies 26, an environmental control system bleed 36 operably coupled to the fuselage 22 or any other bleed port located on the aircraft 20. The brakes 32 are used to slow the aircraft 20 during landing and the wheel 31 and brakes 32 rotate during landing when the landing gear 30 is in contact with a landing surface, outputting wasted mechanical energy. The engine exhaust system exhausts gases generated during combustion within engine assemblies 26 and the engine exhaust system output 38 exhausts the gases to the atmosphere, outputting wasted mechanical energy. An anti-ice system circulates gases generated by the engine assemblies 26 within the engine assemblies 26 and wing assemblies 24 to prevent ice build-up during flight and the anti-ice system bleed 34 releases the gases to the atmosphere, outputting wasted mechanical energy. An environmental control system controls the gases, such as oxygen, within the fuselage 22 and the environmental control system bleed 36 releases the gases to atmosphere, outputting wasted mechanical energy.

The transient, energy consuming components may include a thrust reverser 40 including a thrust reversing actuation system (TRAS) 42, a variable area nozzle 44 having a variable area nozzle actuation system 46, auxiliary aerodynamic devices and a steering system 48 which are operated for short durations of time, thereby requiring and consuming energy for short durations of time. It will be understood that the term “short” according to this invention is generally considered to be less than three minutes. The thrust reverser 40 is a movable portion of the engine assembly 26 controlled by the thrust reversing actuation system (TRAS) 42 to temporarily divert the engine exhaust so that the exhaust produced is directed forward, rather than aft. This acts against the forward travel of the aircraft 20, providing deceleration to help slow the aircraft 20 just after touch-down, reducing wear on the brakes 32 and enabling shorter landing distances. The variable area nozzle 44 defines the exit area that the exhaust gases generated during operation of the engine assemblies 26 exit the engines assemblies 26 through. The exit area is varied by the variable area nozzle actuation system 46 to achieve optimum performance of the engine assemblies 26 during specific flight regimes such as take-off, cruise, and the like. The steering system 48 is operably coupled to the landing gear 30 in order to steer the aircraft 20 during taxiing. The thrust reversing actuation system (TRAS) 42, variable area nozzle actuation system 46 and steering system 48 utilize actuators motors or pumps during operation and are operated for short durations of time, thereby requiring and consuming energy for short durations of time. Other transient, energy consuming components may include vectoring nozzles, afterburners, speed brakes, spoilers and other aerodynamic devices.

At least one ERU 60 may be operably coupled to at least one of the energy output components to recover wasted mechanical energy. It is envisaged that an ERU 60 may be operably coupled to each of the aircraft brakes 32, engine exhaust system output 38 and, anti-ice system bleed 34 and environmental control system bleed 36. At least one ERU 60 is also operably coupled to an ESU 80 housed within the aircraft. Although the ESU 80 is shown schematically as mounted within the fuselage 22, the ESU 80 may be mounted anywhere within the aircraft 20. For example, the ESU 80 may be mounted within a pylon structure for supporting the engine assemblies 26 within the cowl, such as under the fan cowl door.

The aircraft 20 may also be equipped with a system control module 52 and an engine control module 50. The system control module 52 and engine control module 50 may be operably coupled to and configured to control the operation of the energy output components, the transient, energy consuming components, the at least one ERU 60 and the ESU 80. The system control module 52 and engine control module 50 may also be configured to control other aircraft systems which may include but are not limited to: an electrical system, an oxygen system, hydraulics and/or pneumatics system, a fuel system, a propulsion system, navigation systems, flight controls, audio/video systems, an Integrated Vehicle Health Management (IVHM) system, Onboard Maintenance System, Central Maintenance Computer, Crew Alert System (CAS), Onboard Maintenance System (OMS) and systems associated with the mechanical structure of the aircraft 20. It will be understood that the system control module 52 and engine control module 50 may be configured to optimize the operation of such components and systems and to control the components and systems automatically.

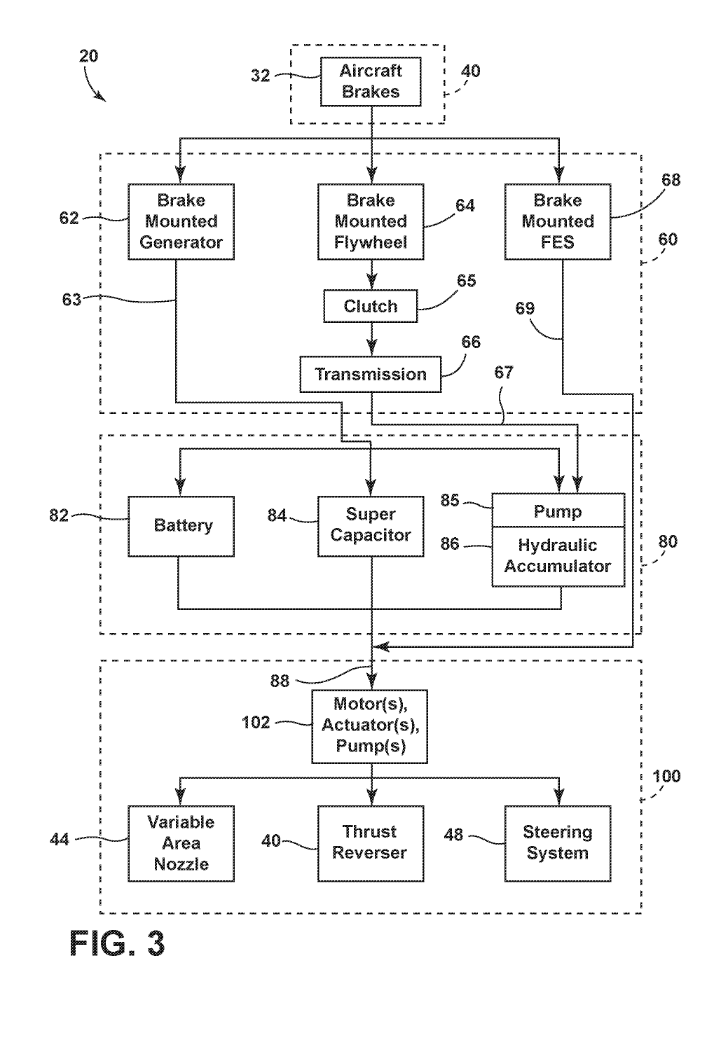

Referring now to FIG. 3, when coupled to the aircraft brakes 32, the ERU 60 may comprise a brake mounted generator 62, a brake mounted flywheel 64 in combination with a clutch 65 and transmission 66, or a brake mounted flywheel energy storage device (FES) 68. The brake mounted generator 62 is operably coupled to the aircraft brakes 32 so as to convert the mechanical energy from the aircraft brakes 32 into an electrical energy output 63.

The brake mounted flywheel 64 is operably coupled to the aircraft brakes 32 so that the mechanical energy from the aircraft brakes 32 is transferred to the brake mounted flywheel 64. The clutch 65 is operably coupled to the transmission 66 so as to selectively couple the transmission 66 and brake mounted flywheel 64 to transfer the mechanical energy to the transmission 66, providing a mechanical energy output 67. The transmission 66 may be any common type of transmission such as a continuously variable transmission (CVT).

The brake mounted FES 68 is operably coupled to the aircraft brakes 32 so that the mechanical energy from the aircraft brakes 32 is transferred to the brake mounted FES 68. A flywheel within the brake mounted FES 68 is spun by the aircraft brakes 32 so that the mechanical energy of the flywheel is stored by the brake mounted FES 68. The brake mounted FES 68 may contain magnetic materials and may be configured as a permanent magnet generator such that the brake mounted FES 68 acts as an electro-mechanical battery, storing the mechanical energy in the rotation of the flywheel and selectively providing an electrical energy output 69.

The ESU 80 may comprise a battery 82 such as a lithium ion battery, a super capacitor 84, a hydraulic accumulator 86 or a hybrid thereof. The electrical energy output 63 from the brake mounted generator 62 is stored within battery 82 or super capacitor 84 as chemical energy or electrical energy, respectively. The battery 82 or super capacitor 84 may then selectively output electrical energy 88 to the TECC 100.

The hydraulic accumulator 86 includes a small motor and pump 85 powered by the electrical energy output 63 from the brake mounted generator 62 such that the electrical energy output 63 powers the motor and pump 85 to pressurize a fluid within the hydraulic accumulator 86. In this way, the electrical energy output 63 used to power the motor and pump 85 is stored within the hydraulic accumulator 86 as mechanical energy in the form of fluid pressure. The hydraulic accumulator 86 may then selectively output mechanical energy 88 to the TECC 100. It is also contemplated that energy stored in the battery 82 or super capacitor 84 may be may be used to power the motor and pump 85 such that the energy is further stored in the hydraulic accumulator 85.

The mechanical energy output 67 from the brake mounted flywheel 64, clutch 65 and transmission 66 may also be used to power a motor and/or pump provided with the hydraulic accumulator 86 such that the mechanical energy output 67 is stored within the hydraulic accumulator 86 as mechanical energy in the form of fluid pressure. The hydraulic accumulator 86 may then selectively output mechanical energy 88 to the TECC 100. Alternatively, the brake mounted flywheel 64, clutch 65 and transmission 66 may be operably coupled to the TECC 100 such that the mechanical energy output 67 may be selectively supplied to the TECC 100 without the need for the ESU 80.

In the case if the brake mounted FES 68, no ESU 80 is needed because the brake mounted FES 68 is capable of storing the mechanical energy generated by the aircraft brakes 32 and to output electrical energy 88 to the TECC 100. In essence, the brake mounted FES 68 serves as the ERU 6 and the ESU 80.

As described above, the energy 88 is used to power motor(s), actuator(s), or pump(s) 102 which in turn, operate the variable area nozzle 44, thrust reverser 40, steering system 48 or other another TECC 100.

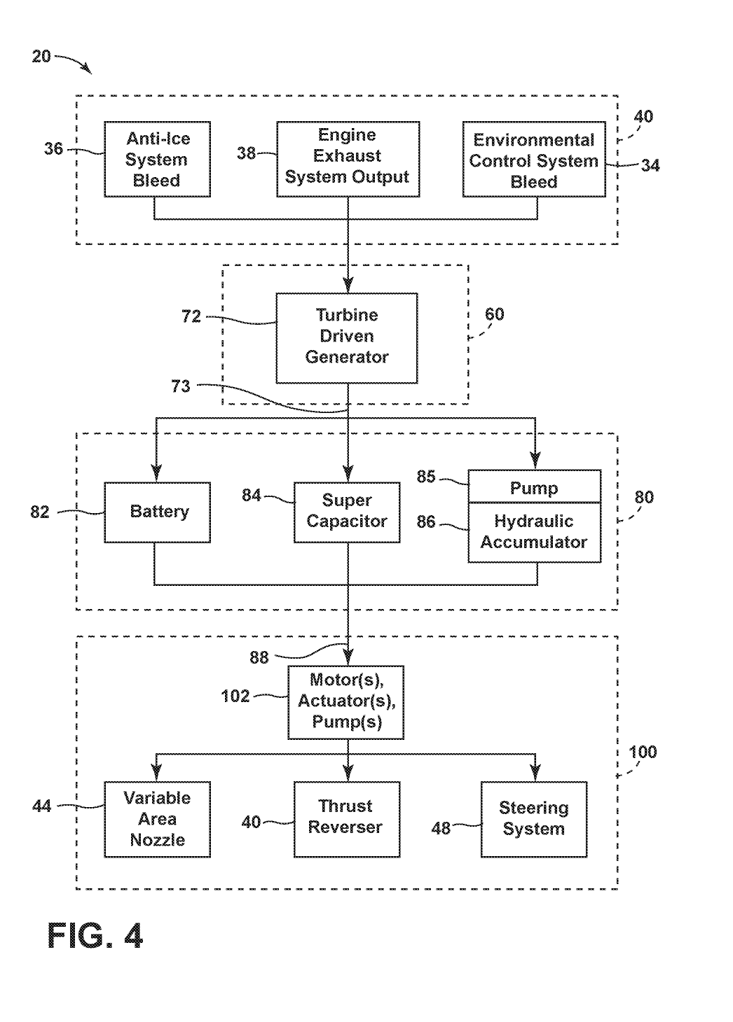

Referring now to FIG. 4, when coupled to the anti-ice system bleed 34, engine exhaust system output 38 or environmental control system bleed 36, the ERU 60 may comprise a turbine driven generator 72. The turbine driven generator 72 comprises a turbine operable coupled to a generator by a generator input. The turbine driven generator 72 is operably coupled to anti-ice system bleed 34, engine exhaust system output 38 or environmental control system bleed 36 so as to convert the thermal and mechanical energy from the gases into an electrical energy output 73. The gases rotate the turbine which in turn rotates a generator input, powering the generator and producing an electrical energy output 73.

The electrical energy output 73 is stored as chemical energy or electrical energy in the battery 82 or super capacitor 84, respectively, or mechanical energy in the form of fluid pressure in the hydraulic accumulator 86 as described above. The battery 82, super capacitor 84 or hydraulic accumulator 86 may then selectively supply electrical or mechanical energy 88 to the TECC 100. The energy 88 is used to power motor(s), actuator(s), or pump(s) 102 which in turn, operate the variable area nozzle 44, thrust reverser 40, steering system 48 or other another TECC 100.

Referring again to FIG. 1 and in one non-limiting example, to adequately power the TECC 10 for the required duration, the ESU 8 may be configured to store up to 5400 kilojoules of energy, to output the stored energy at an output rate up to 30 kilowatts and to output the output rate for between 30 and 180 seconds. The ESU 8 may also have a specific energy configured to adequately power the TECC 10 for the required duration and to minimize the weight that the ESU 8 adds to the aircraft 2. The ESU 8 may also be configured to as to only store enough energy to supply the TECC 10 for the required duration of time such that the ESU 8 discharges all of the energy stored in the ESU 8 at a rate adequate to the power the TECC 10 in the required duration of time the TECC 10 must operate. In this way, the weight of the ESU 8 may be minimized. In one example, a thrust reverser may be required to operate from between 30 to 60 seconds and requires a specific amount of power to operate. Accordingly, the ESU 8 is configured to store enough energy to supply the specific amount of power to the thrust reverser over the 30 to 60 seconds and such that all of the energy stored in the ESU 8 is discharged after the 30 to 60 seconds. It will be understood that these power needed to operate the TECC 10 and duration of time the TECC 10 must operate may vary based on the model of the aircraft 2 and that the ERU 6 and ESU 8 configuration may also vary accordingly.

The embodiments described above provide for a variety of benefits including that waste energy is recovered and utilized to power transient, energy consuming components. Engine mounted electrical generators or hydraulic pumps and their distribution systems are sized to accommodate peak power demands that include systems that may only require power for a short duration. This also requires engine performance to support this power generation. Use of existing waste energy may allow smaller power generation systems and reduce engine performance requirements, reducing weight and/or fuel consumption. Powering components operated for transient, short durations of time allows the energy storage unit to be sized and configured to only store the energy and supply the power required by the components over the short durations of time they are operated, minimizing the weight added to the aircraft.

To the extent not already described, the different features and structures of the various embodiments may be used in combination with each other as desired. That one feature may not be illustrated in all of the embodiments is not meant to be construed that it may not be, but is done for brevity of description. Thus, the various features of the different embodiments may be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An aircraft comprising:
An energy output component (EOC) outputting waste energy;
an energy recovery unit (ERU) operably coupled to the EOC and converting the waste energy into one of electrical energy or mechanical energy;
an energy storage unit (ESU) operably coupled to the ERU and storing the one of electrical energy or mechanical energy recovered from the waste energy; and
a transient, energy consuming component (TECC) operably coupled to the ESU and receiving one of electrical energy or mechanical energy from the ESU during the operation of the TECC.

2. The aircraft of claim 1 wherein the ESU can output the stored electrical energy at an output rate up to 30 kilowatts.

3. The aircraft of claim 2 wherein the ESU can output at the output rate for between 30 and 180 seconds.

4. The aircraft of claim 3 wherein the ESU can store up to 5400 kilojoules.

5. The aircraft of claim 1 wherein the ESU discharges substantially all energy stored from the one of electrical energy or mechanical energy recovered from the waste energy during operation of the TECC.

6. The aircraft of claim 1 wherein the component outputs mechanical waste energy.

7. The aircraft of claim 6 further comprising landing gear having a wheel, with the EOC comprising the wheel, and a rotation of the wheel outputs the mechanical waste energy.

8. The aircraft of claim 7 wherein the ERU further comprises a generator coupled to the wheel to generate electricity from the rotation of the wheel.

9. The aircraft of claim 7 wherein the ERU further comprises a flywheel energy storage device coupled to wheel to store the mechanical waste energy from rotation of the wheel and generate electricity.

10. The aircraft of claim 9 wherein ESU further comprises the flywheel energy storage device.

11. The aircraft of claim 1 wherein the EOC outputs thermal and mechanical waste energy.

12. The aircraft of claim 11 further comprising a turbine engine emitting exhaust gas to form thermal and mechanical waste energy.

13. The aircraft of claim 12 wherein the ERU comprises a turbine driven generator to generate electricity from the thermal and mechanical waste energy.

14. The aircraft of claim 1 wherein the TECC comprises at least one of a thrust reverser, a variable area nozzle, auxiliary aerodynamic devices or a steering system.

15. The aircraft of claim 1 wherein the EOC comprises at least one of aircraft brakes, an engine exhaust system output, an anti-ice system bleed or an environmental control system bleed.
